(19) United States
(12) Patent Application Publication
(10) Pub. No.: US 2010/0013182 A1
(43) Pub. Date: Jan. 21, 2010

(54) Tree stand wheel attachment

(76) Inventors: Patrick J. Kergosien, Bay St. Louis, MS (US); Rick Kergosien, Long Beach, MS (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/219,292

(22) Filed: Jul. 18, 2008

(51) Int. Cl. B62B 5/00

(52) U.S. Cl. 280/204

(57) ABSTRACT

The tree stand wheel attachment has a rigid plate adapted for attachment to a tree stand. A plurality of wheel attachment struts is disposed on the plate. The struts are adapted for fitting forked wheel assemblies thereto. A laterally opposing pair of the struts includes a first pair of axle couplings, the first pair of axle couplings accommodating an axle and wheel assembly. A second pair of axle couplings is disposed directly on the plate to provide an alternate location for the axle and wheel assembly. A plurality of holes in the plate allows bolts to pass through the holes to secure attachment of the tree stand wheel attachment base to the tree stand via rigid compression straps. Rigid handles are attached to the tree stand to facilitate manipulation by a user. The tree stand wheel attachment may be operated in wheelbarrow fashion to carry equipment and game.

### BACKGROUND OF THE INVENTION

1. Field of the Invention

The present invention relates generally to hunting accessories, and more particularly to a tree stand wheel attachment for converting a hunting tree stand to a cart for carrying equipment/game.

2. Description of the Related Art

In heavily hunted woodland areas, hunting from tree stands is becoming one of the most productive and popular hunting methods. Tree stands usually fold into a more compact package, allowing the tree stand to be carried on the hunter's back in the manner of a backpack. When the hunter travels to and from a hunting site, the hunter has to carry a considerable amount of equipment, including a firearm or bow, ammunition or arrows, the tree stand, a flashlight, a survival kit, provisions, and game calls. Because the tree stand is carried on the back, the hunter is precluded from wearing a backpack, and oftentimes he or she will have both hands full with equipment when trekking to the hunting site.

Another piece of equipment that hunters often find useful is the game carrier, which is used to transport harvested game out of the hunting fields. This device somewhat resembles a wheelbarrow, having a frame that is supported on an axle or a single wheel.

Therefore, if the hunter plans to use a game carrier to haul his game out of the hunting area, he or she must usually make two trips, a first trip to carry the tree stand and other equipment to the hunting site, and a second trip to carry the game carrier to the hunting site.

For the above reasons, combination tree stand/game carriers have been proposed in the related art. However, hunters who have already invested in a tree stand would prefer not to incur the substantial expense of a new combination tree stand/game carrier. Moreover, hunters who have become comfortable with the use and operation of their old tree stands would rather not give up their old tree stands. Therefore, it would be desirable to have an attachment that can be used to retrofit an existing tree stand for conversion of the existing tree stand into a combination tree stand/game carrier.

Thus, a tree stand wheel attachment solving the aforementioned problems is desired.

### SUMMARY OF THE INVENTION

The tree stand wheel attachment comprises a rigid plate adapted for attachment to a tree stand. A plurality of wheel attachment struts is disposed on the plate. The struts are adapted for fitting forked wheel assemblies thereto. A laterally opposing pair of the struts includes a first pair of axle couplings that accommodate an axle and wheel assembly. A second pair of axle couplings is disposed directly on the plate to provide an alternate location for the axle and wheel assembly.

A plurality of holes in the plate allows bolts to pass through the holes to secure attachment of the wheel attachment base to the tree stand via rigid compression straps. Rigid handles are attached to the tree stand to facilitate manipulation by a user.

These and other features of the present invention will become readily apparent upon further review of the following specification and drawings.

### BRIEF DESCRIPTION OF THE DRAWINGS

FIG. 1 is an environmental perspective view of an embodiment of a tree stand wheel attachment according to the present invention having a pair of wheel assemblies.

FIG. 2 is an environmental perspective view of an embodiment of a tree stand wheel attachment according to the present invention having a single wheel assembly.

FIG. 3 is a bottom perspective view of the plate of the tree stand wheel attachment according to the present invention.

FIG. 4 is a bottom view of the plate of the tree stand wheel attachment according to the present invention.

FIG. 5 is a bottom perspective view of the tree stand wheel attachment of FIG. 1.

FIG. 6 is a bottom perspective view of a first configuration of the tree stand wheel attachment of FIG. 2.

FIG. 7 is a bottom perspective view of a second configuration of the tree stand wheel attachment of FIG. 2.

FIG. 8 is a rear view of the tree stand wheel attachment of FIG. 1.

FIG. 9 is a front view of the tree stand wheel attachment of FIG. 1.

FIG. 10 is a perspective view of compression straps for the tree stand wheel attachment according to the present invention.

FIG. 11 is a top view of the tree stand wheel attachment according to the present invention, the wheel and axle assemblies being omitted.

FIG. 12 is a bottom view of the tree stand wheel attachment according to the present invention, the wheel and axle assemblies being omitted.

Similar reference characters denote corresponding features consistently throughout the attached drawings.

### DETAILED DESCRIPTION OF THE PREFERRED EMBODIMENT

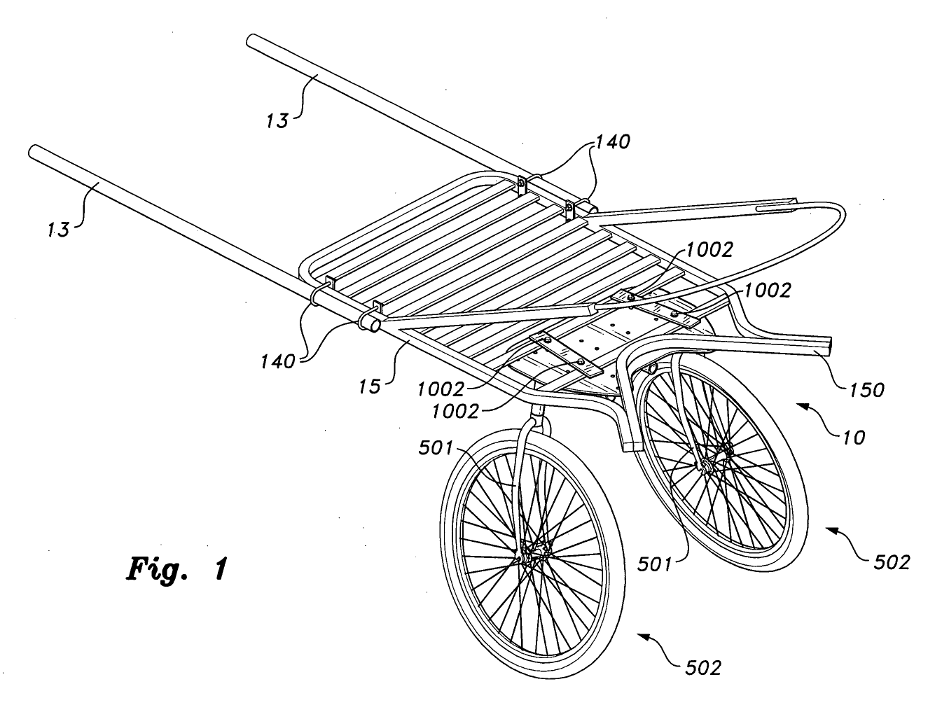

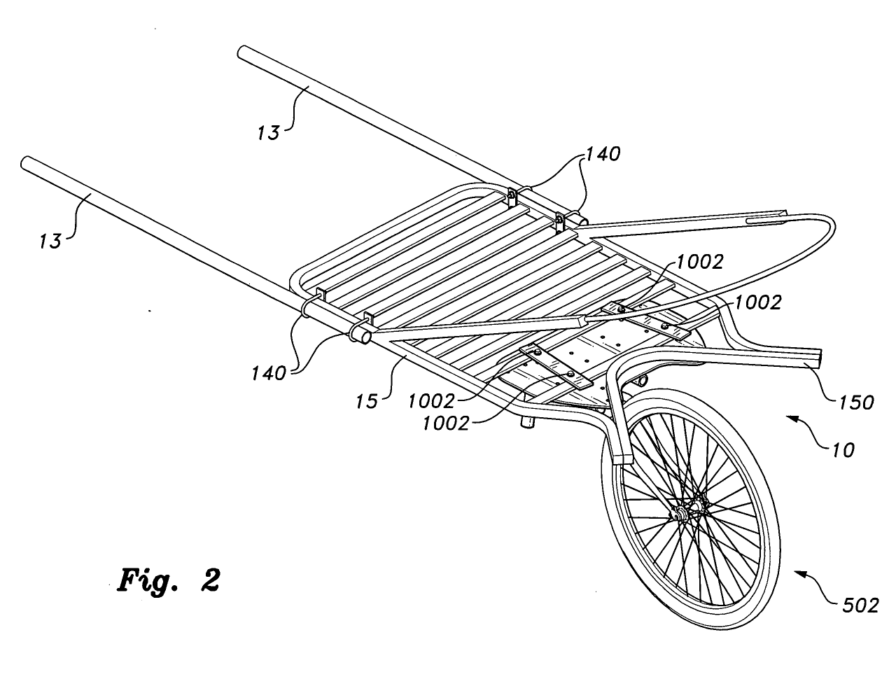

As shown in FIGS. 1-3, the tree stand wheel attachment 10 comprises a rigid plate 12 adapted for attachment to a tree stand 15. A lateral edge 120 of plate 12 may be contoured to follow the shape of a bite bar 150 of tree stand 15. Wheel attachment struts 18, 19 and 20 are disposed on the plate 12. The struts 18, 19, and 20 are adapted for attaching forked wheel assemblies 502 thereto. For example, the wheel attachment struts 18, 19, 20 may be tubular to facilitate a compression fit with a forked wheel assembly 502. Alternatively, it should be understood to persons having ordinary skill in the art that mechanical fasteners of any type may be used to secure the wheel assemblies 502 to the struts 18, 19, 20. Preferably, strut 18 is disposed along a longitudinal centerline of plate 12 and arranged so that wheel attachment 502 connects to form a negative camber angle with respect to a planar orientation of base 12. Struts 19 are laterally opposing and include a pair of axle couplings 14 attached thereto for accommodating an axle 800 connected to wheels W. Preferably, the struts 19 are disposed on the plate 12 in a manner that provides a negative camber angle of forked wheel assemblies 502 when attached (the camber angle being measured with respect to a plane oriented perpendicular to base 12). Moreover, struts 19 may be disposed along a lateral centerline of plate 12. Preferably, strut 20 is disposed along a longitudinal centerline of plate 12 and arranged such that wheel attachment 502 connects to form a zero degree camber angle with respect to a planar orientation of base 12.

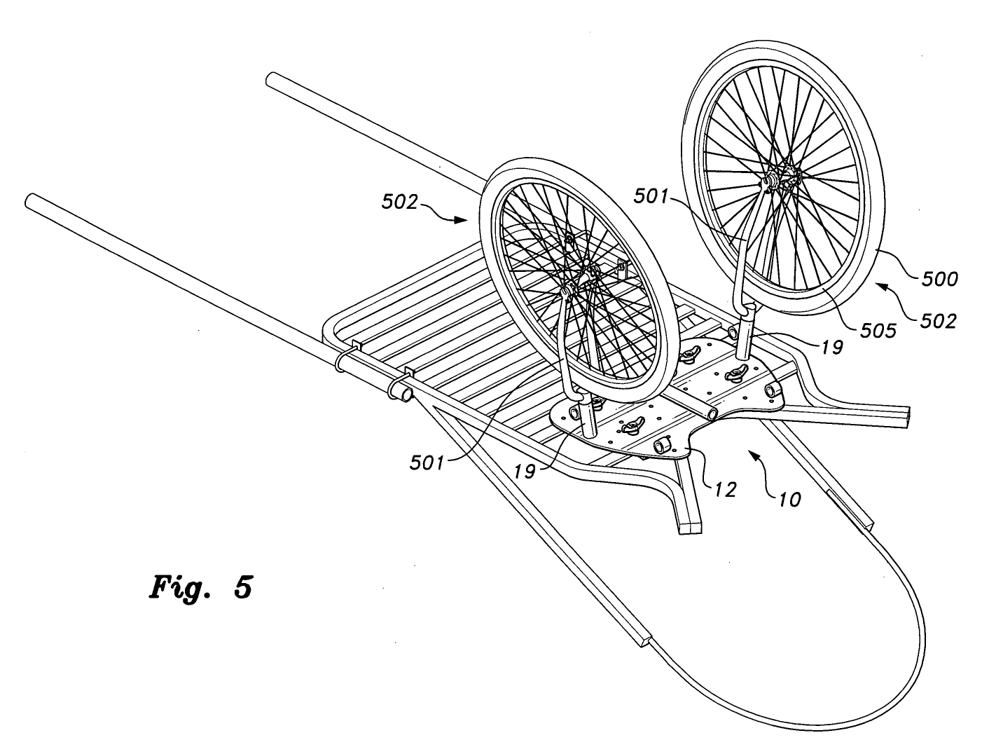

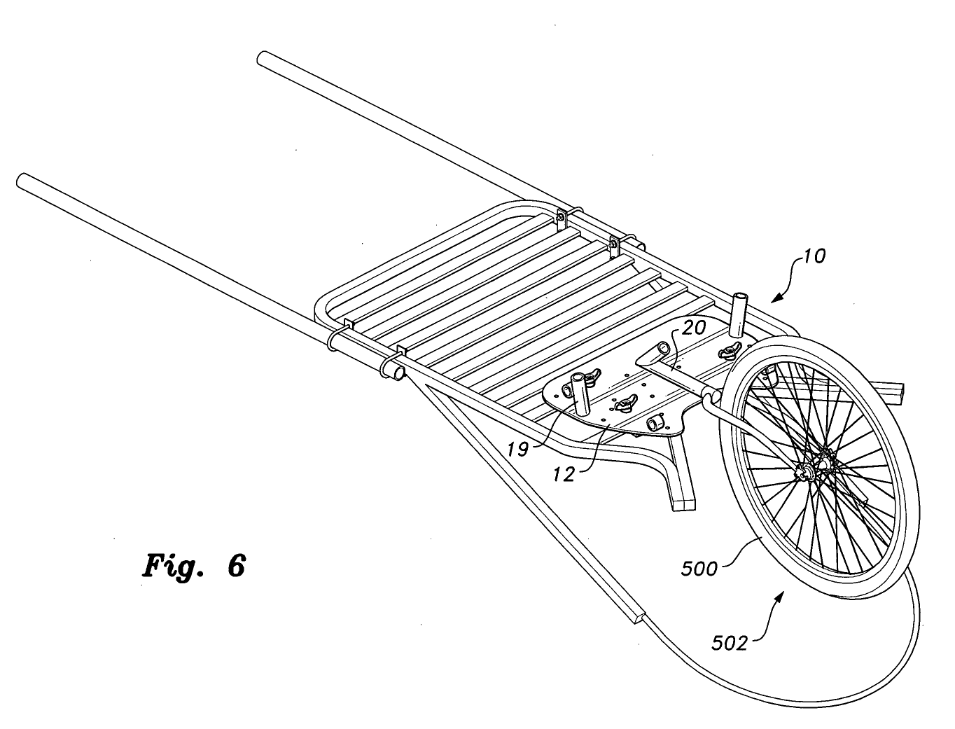

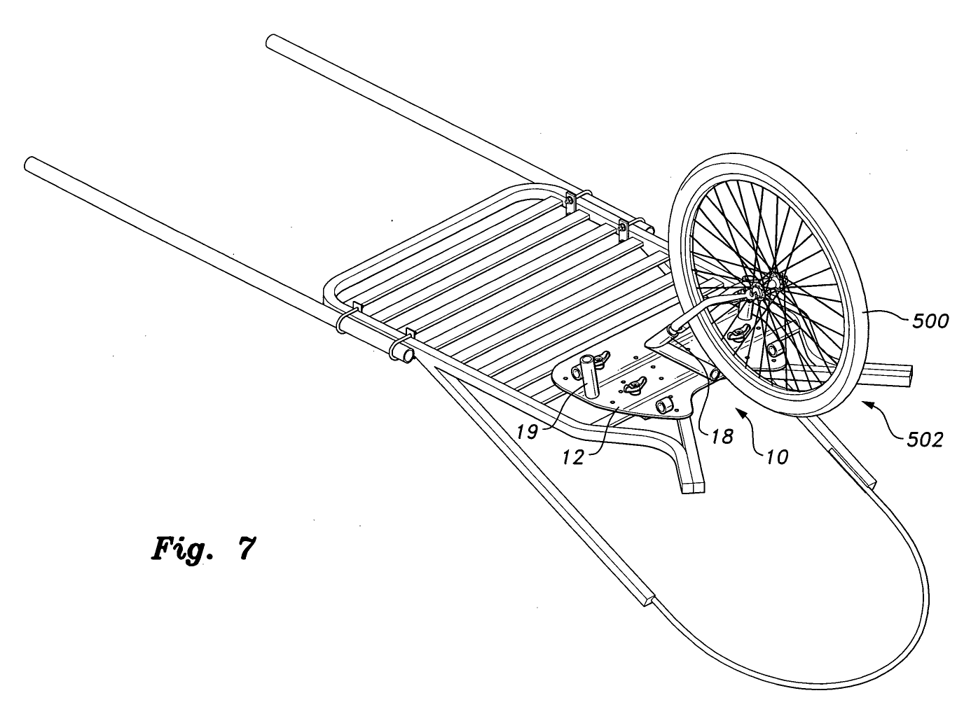

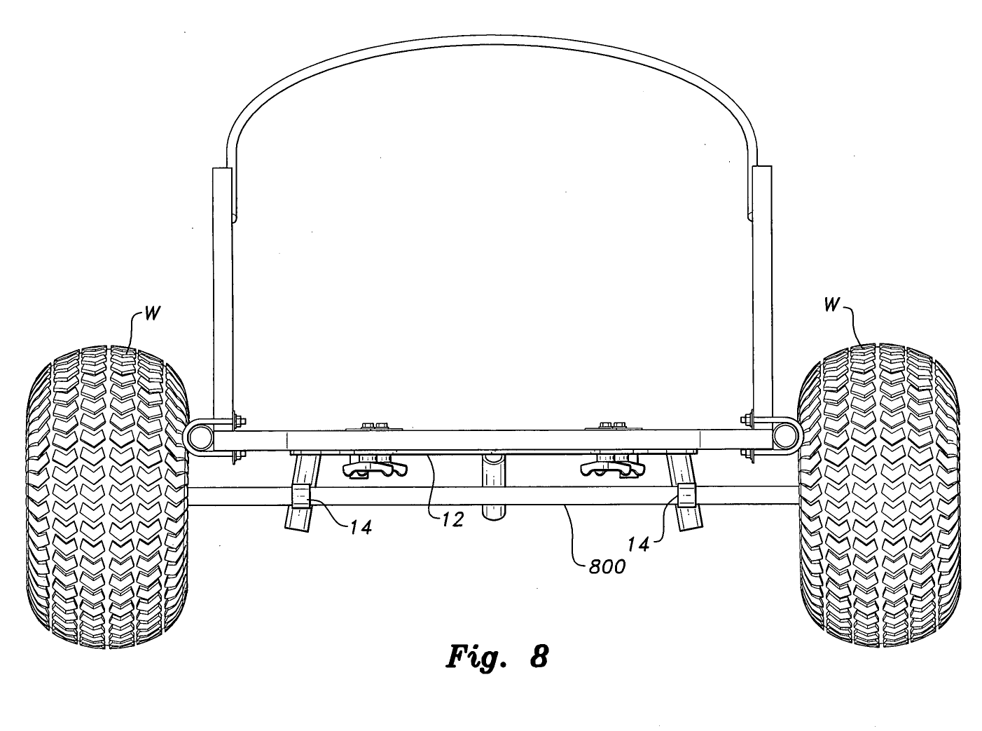

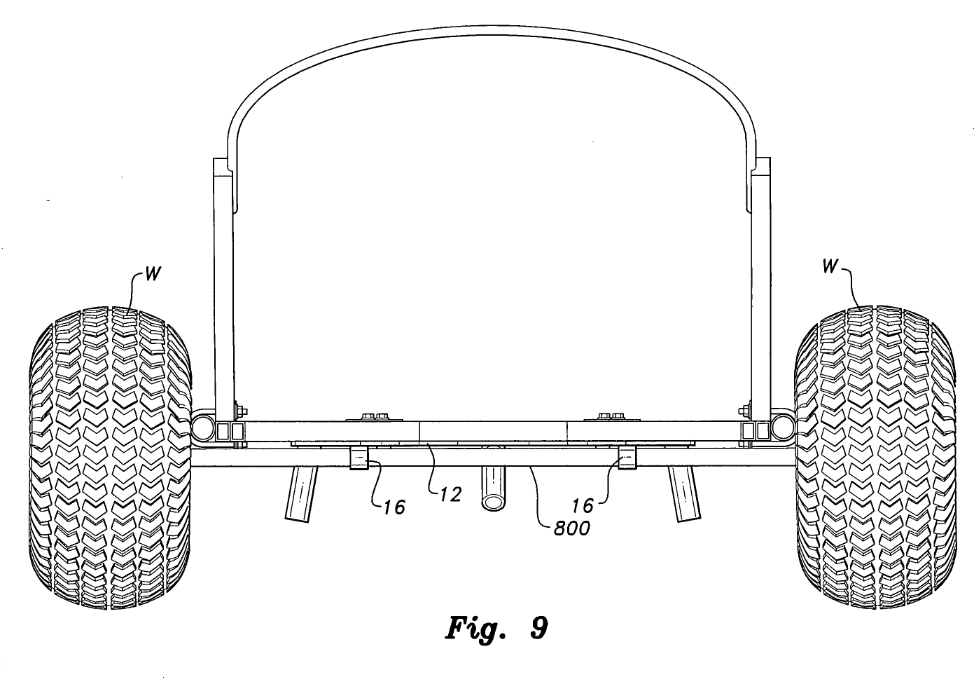

Axle couplings 16 are also disposed directly on the plate 12 to provide an alternate location for the axle 800 and wheel set W. Utilizing different combinations of struts or axle couplings, the wheel assemblies and axles can be configured in five different ways (as shown in FIGS. 5, 6, 7, 8 and 9) to handle a specific cargo load and terrain requirement. The wheel assembly 502 is comprised of a tire 500 on a spoked wheel 505, the spoked wheel being rotatably mounted on an axle extending through a fork 501.

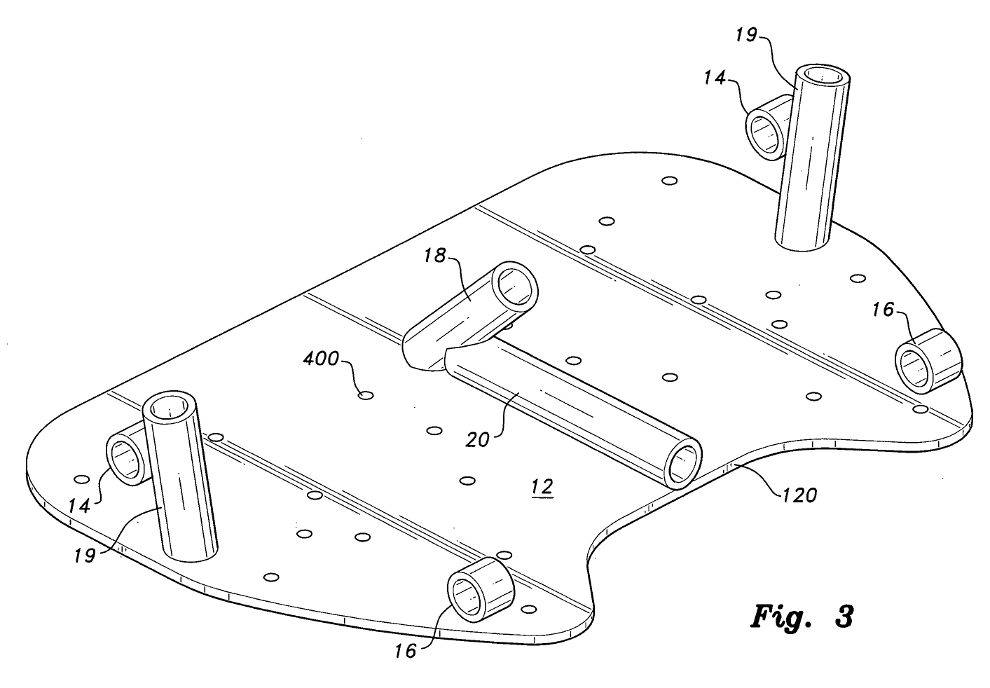

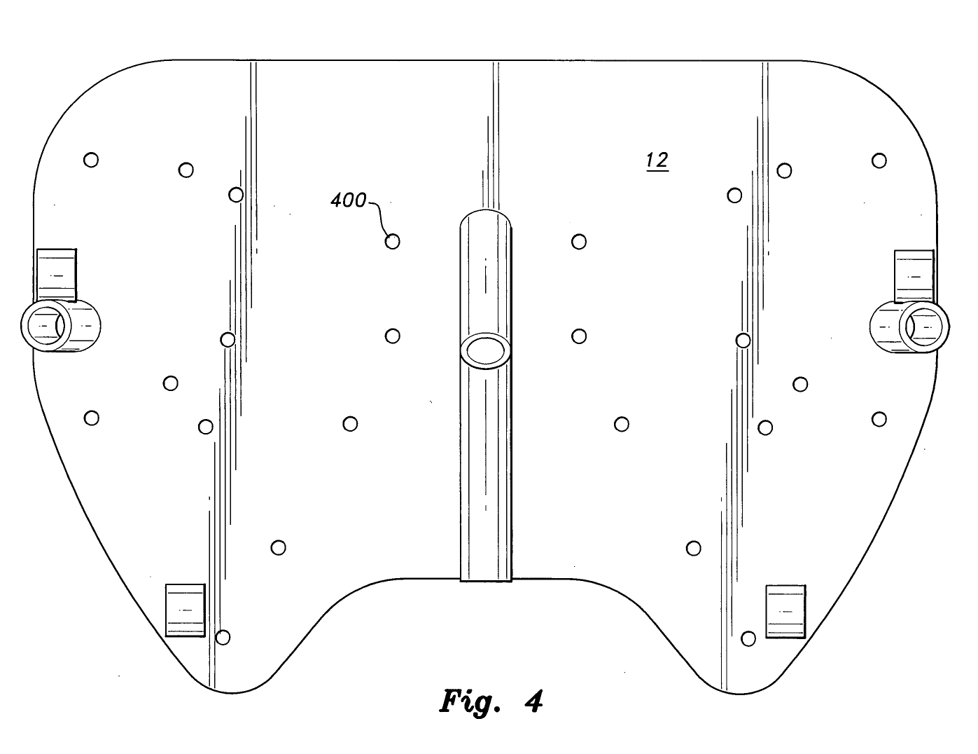

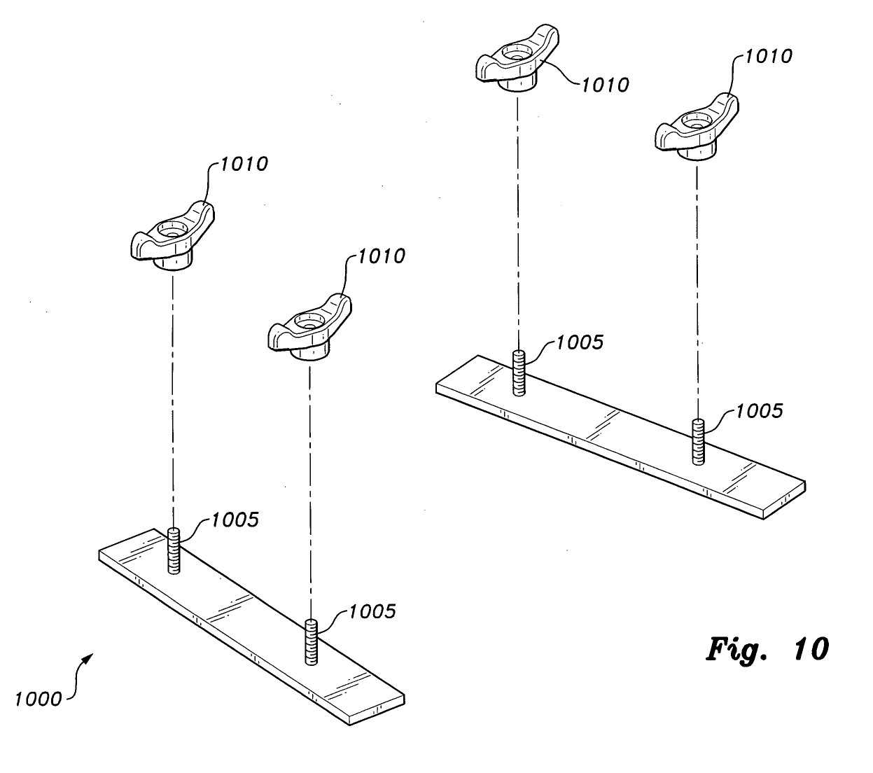

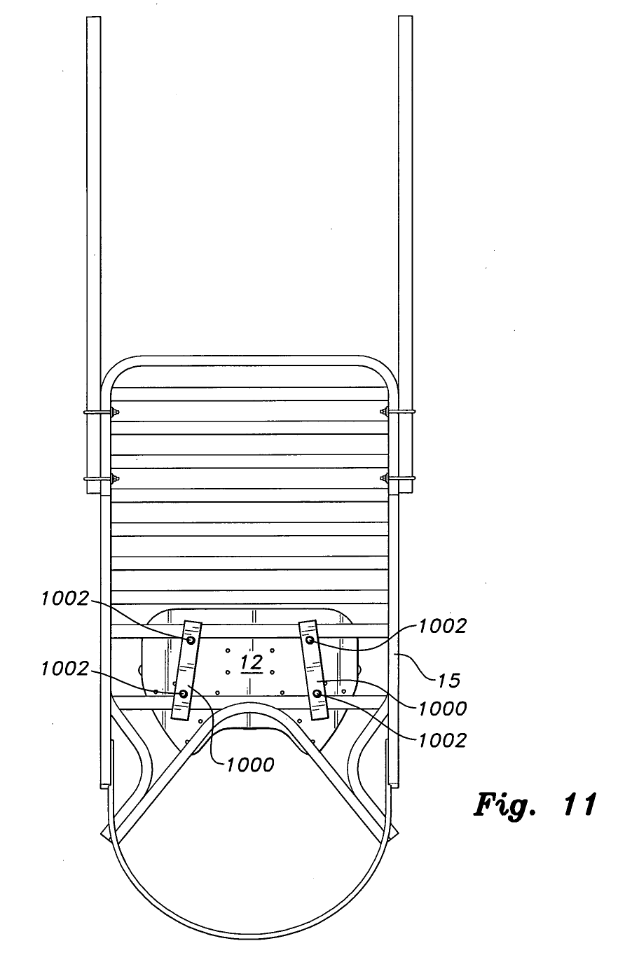

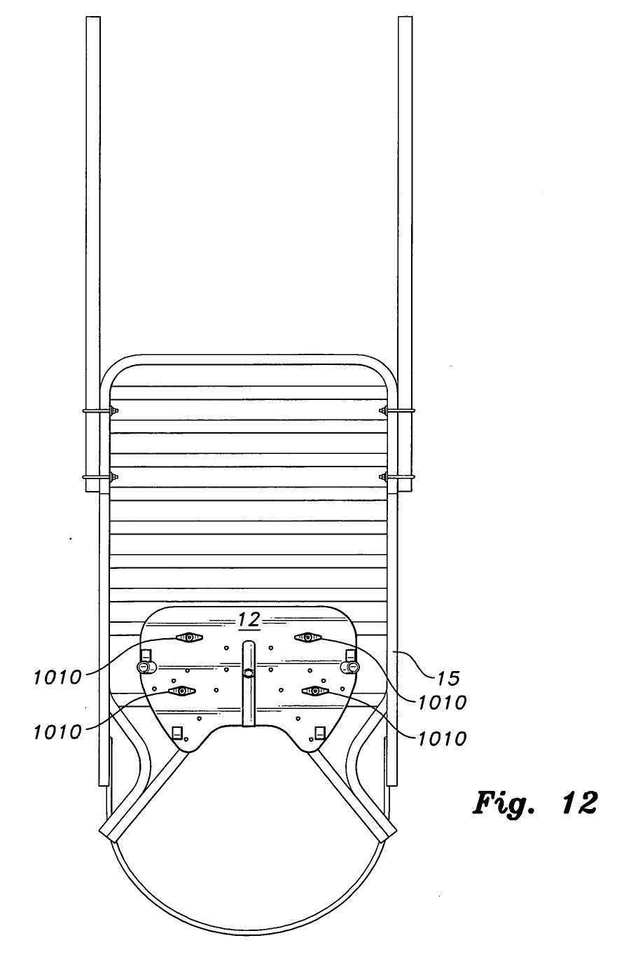

As shown in FIGS. 3-4 and 11-12, a plurality of holes 400 in the plate 12 allows threaded shanks 1005 (most clearly shown in FIG. 10) of bolts 1002 to pass through the holes 400, allowing attachment of the plate 12 to the tree stand 15 when threaded knobs 1010 are threaded onto the shanks 1005. Shanks 1005 of the bolts 1002 pass through holes in rigid compression straps 1000 and through existing spaces in the floor of tree stand 15 and extend into holes 400 of the plate 12. The threaded fasteners 1010 hold the stand 15 compressed securely between the plate 12 and the rigid compression straps 1000.

Elongate rigid handles 13 are attached to the tree stand 15 with U-bolt retaining assemblies 140 to facilitate manipulation by a user. The device may be used in the manner of a wheelbarrow to carry equipment and game animals after a successful hunt.

It is to be understood that the present invention is not limited to the embodiment described above, but encompasses any and all embodiments within the scope of the following claims.

We claim:

1. A tree stand wheel attachment, comprising:
a plate adapted for attachment to a tree stand;
a plurality of wheel attachment struts attached to the plate;
at least one wheel assembly removably attached to at least one of the wheel attachment struts; and
elongate handles adapted for removable attachment to the tree stand;
wherein the handles may be grasped to wheel the tree stand in wheelbarrow fashion to carry equipment and game.

2. The tree stand wheel attachment according to claim 1, wherein the plurality of wheel struts includes a pair of laterally opposed wheel struts, said at least one wheel assembly comprising a pair of wheel assemblies attached to the laterally opposed wheel struts, respectively.

3. The tree stand wheel attachment according to claim 2, further comprising:
a first pair of laterally opposed axle couplings affixed to said plate;
an axle removably disposed through the first pair of axle couplings; and
a pair of wheels mounted to opposite ends of the axle.

4. The tree stand wheel attachment according to claim 3, further comprising a second pair of laterally opposed axle couplings affixed to the laterally opposed wheel struts, respectively, said axle being removably disposed through the second pair of axle couplings.

5. The tree stand wheel attachment according to claim 2, wherein the pair of laterally opposed wheel struts form a negative camber angle.

6. The tree stand wheel attachment according to claim 1, wherein the plurality of wheel struts includes a wheel strut disposed along a longitudinal centerline of said plate, the wheel strut providing a zero degree camber angle of an attached wheel assembly with respect to a planar orientation of the plate.

7. The tree stand wheel attachment according to claim 1, wherein the plurality of wheel struts includes a wheel strut extending downward from a longitudinal centerline of the plate, the wheel strut forming a negative camber angle.

8. The tree stand wheel attachment according to claim 1, wherein the wheel struts are tubular, the tubular wheel struts facilitating a compression fit attachment of the wheel assemblies to the struts.

9. The tree stand wheel attachment according to claim 1, wherein the at least one wheel assembly comprises:
a wheel;
a tire mounted on the wheel; and
a mounting fork, the wheel being rotatably mounted on the mounting fork, the mounting fork being removably attachable to the wheel strut.

10. The tree stand wheel attachment according to claim 1, wherein said plate has a plurality of holes defined therein, the tree stand wheel attachment further comprising:
a plurality of elongate compression members; the elongate compression members having a plurality of holes defined therein;
a plurality of bolts insertable through the holes of the plate and holes of the compression members;
a plurality of nuts removably engaging the bolts, said plate and said compression members being adapted for clamping the tree stand therebetween in order to attach said plate to the tree stand.

11. The tree stand wheel attachment according to claim 1, further comprising a plurality of U-bolt assemblies adapted for removably attaching the handles to the tree stand.
